(19) United States
(12) Patent Application Publication
(10) Pub. No.: US 2012/0095772 A1
(43) Pub. Date: Apr. 19, 2012

(54) PORTABLE DEVICE, BATTERY PACK, REPORTING METHOD AND REPORTING PROGRAM

(76) Inventor: Takanori Asai, Tokyo (JP)

(21) Appl. No.: 13/378,441

(22) PCT Filed: Jun. 30, 2010
(86) PCT No.: PCT/JP2010/061166

§ 371 Date: Dec. 15, 2011

(30) Foreign Application Priority Data
Jul. 9, 2009 (JP) 2009-162421

(51) Int. Cl. G06Q 10/00

(52) U.S. Cl. 705/1.1

(57) ABSTRACT

A portable device which is driven by a chargeable and dischargeable secondary battery mounted on a battery pack having a memory circuit, in which identification information of the secondary battery is stored, the portable device including a defective battery information receiving unit configured to receive defective battery information which is delivered from a defective battery ID information delivering organization; a requesting unit configured to request obtaining the identification information of the secondary battery stored in the memory circuit; a determining unit configured to determine whether the identification information of the secondary battery is included in the defective battery information; and a report controlling unit configured to report a defect of the secondary battery if it is determined by the determining unit that the identification information of the secondary battery is included in the defective battery information.

### TECHNICAL FIELD

The present invention generally relates to a portable device which is driven by a chargeable and dischargeable secondary battery and in which a battery pack having a memory circuit storing identification information of the secondary battery is installed, a report method using the portable device, and a reporting program executed by the portable device.

### BACKGROUND ART

In recent years, portable devices such as a digital camera and a portable phone are powered by a secondary battery such as a lithium ion battery which may be ordinarily shaped like a battery pack in which a protection circuit is provided to ensure safety in use. Patent Document 1 discloses a portable device in which a battery pack having a protection circuit is described. When a defect occurs in a secondary battery including a battery pack having a protection circuit, it is not possible to ensure safety in use even if the protection circuit is provided. Therefore, it is necessary to exchange the secondary battery. The defect of the secondary battery may occur after delivering the portable device to market in a condition that the secondary battery is installed in the portable device. When a defect occurs after the secondary battery is delivered to the market, information (e.g., manufacturing numbers) specifying the secondary battery causing the defect is publicly reported as news or the like. The user confirms whether the secondary battery built in the portable device is defective based on the published information. If the secondary battery is defective, the user exchanges the secondary battery in the nearest service center or the like.

### PRIOR ART DOCUMENT

[Patent Document 1] Japanese Laid-open Patent Publication No. 2001-169465

### DISCLOSURE OF THE INVENTION

### Problems to be Solved by the Invention

However, in the conventional method, if information specifying the secondary batteries having the defects is not transmitted, the secondary battery having the defects may be continuously used and safety of the use is not ensured. Even when the information of the defect in the secondary battery is transmitted to the user, the user can take the secondary battery out of the portable device. The manufacturing number of the secondary battery is confirmed by viewing a seal attached to the secondary battery to check the information specifying whether the secondary battery is defective.

The present invention is provided to solve the above problems. The objects of the present invention are to provide a portable device, a battery pack, a report method, and a reporting program which can improve safety by reporting the occurrence of the defect in the secondary battery.

### Means for Solving Problems

According to an aspect of an Embodiment, there is provided a portable device which is driven by a chargeable and dischargeable secondary battery mounted on a battery pack having a memory circuit, in which identification information of the secondary battery is stored, the portable device including a defective battery information receiving unit configured to receive defective battery information which is delivered from a defective battery ID information delivering organization; a requesting unit configured to request obtaining the identification information of the secondary battery stored in the memory circuit; a determining unit configured to determine whether the identification information of the secondary battery is included in the defective battery information; and a report controlling unit configured to report a defect of the secondary battery if it is determined by the determining unit that the identification information of the secondary battery is included in the defective battery information.

### Effect of the Invention

According to the Embodiment, it is possible to report occurrence of a defect in a secondary battery to thereby improve the safety.

### BRIEF DESCRIPTION OF DRAWINGS

FIG. 1 illustrates an example hardware structure of a portable device of an Embodiment.

FIG. 2 illustrates a functional structure of the portable device of an Embodiment.

FIG. 3 illustrates a battery pack installed in the portable device of an Embodiment.

FIG. 4 illustrates a hardware structure of a monitoring IC of an Embodiment.

FIG. 5 is a flowchart illustrating an operation of the portable device of an Embodiment.

FIG. 6A illustrates an example report with a report control unit of an Embodiment.

FIG. 6B illustrates another example report with the report control unit of an Embodiment.

FIG. 7 illustrates an example on which a report message is displayed along with map information of an Embodiment.

### BEST MODE FOR CARRYING OUT THE INVENTION

Within an embodiment, when defective battery ID information delivered from a defective battery ID information delivering organization is received, it is determined whether a battery ID stored in a monitoring IC of the secondary battery is included in the defective battery ID information. If the battery ID is included in the defective battery ID information, a message indicative of the defect of the secondary battery is displayed.

### Embodiment

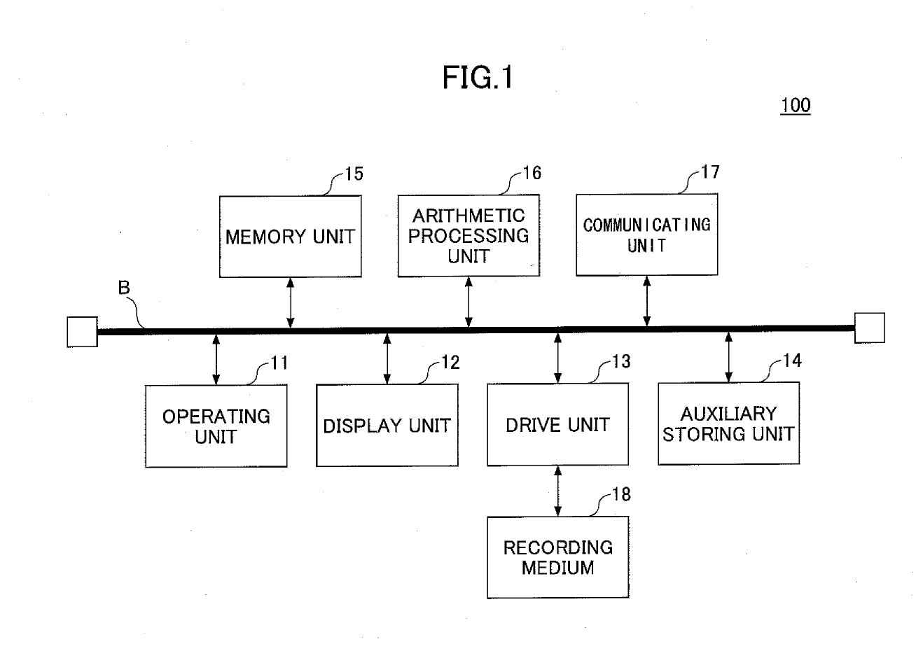

An embodiment of the present invention is described in reference to the figures. FIG. 1 illustrates an exemplary hardware structure of a portable device. The portable device 100 includes an operating unit 11, a display unit 12, a drive unit 13, an auxiliary storing unit 14, a memory unit 15, an arithmetic processing unit 16, and a communication unit 17.

The operating unit 11 is provided to operate the portable device 100. Various signals for operating the portable device 100 are input via the operating unit 11. The operating unit 11 is specifically operation buttons such as a power key and numerical keypads. The display unit 12 is, for example, a liquid crystal display. A guide screen for guiding operations of the portable device 100, the progress of processes carried out in the portable device 100, and so on are displayed on the display unit 12. The communicating unit 17 is provided to cause the portable device 100 to communicate with other portable device or a base station. Specifically, for example, the communicating unit 17 carries out processes of transmitting data via an antenna provided in the portable device 100 and receiving data via the antenna.

A reporting program of an embodiment is at least a part of various programs controlling the portable device 100. The reporting program is provided by a delivery of the recording medium 18, a receipt via the communicating part 17, or the like. The recording medium 18 recording the reporting program is a recording medium which is readable by the portable device 100, such as a memory card.

When the recording medium 18 on which the reporting program is recorded is installed in the drive unit 13, the reporting program is installed in the auxiliary storing unit 14 via the drive unit 13 from the recording medium 18. The reporting program if received from the communicating unit 17 is installed in the auxiliary storing unit 14.

The auxiliary storing unit 14 stores necessary files, data and so on in addition to the installed reporting program. The memory unit 15 reads the reporting program from the auxiliary storing unit 14 at a time of starting up the portable device 100 and deploys the reporting program in the memory. The arithmetic processing unit 16 executes various processes described later in conformity with the reporting program deployed in the memory unit 15.

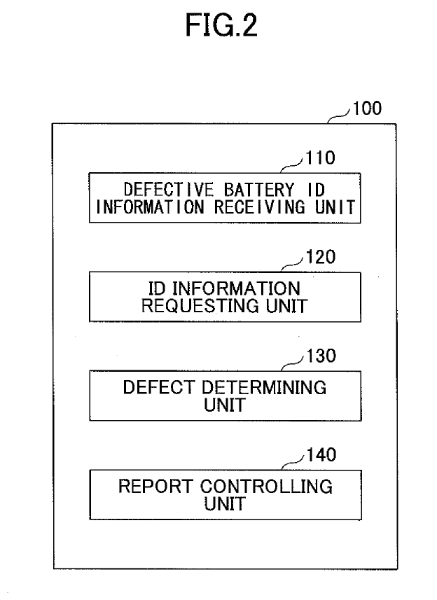

Next, referring to FIG. 2, the portable device 100 is described. FIG. 2 illustrates a functional structure of the portable device 100. The portable device 100 includes a defective battery ID information receiving unit 110, an ID information requesting unit 120, a defect determining unit 130, and a report controlling unit 140.

The defective battery ID information receiving unit 110 receives defective battery ID information delivered from a center server (not illustrated) provided by a defective battery ID information delivering organization. The defective battery ID information is described next. A carrier side of providing communication service for the portable device 100 delivers information for specifying the defective secondary battery to the portable device 100 when the defect occurs after the secondary battery is delivered to the market. The information for specifying the defective secondary battery is defective battery ID information. The defective battery ID information includes information identifying the secondary battery which is supposed to be defective. If it is supposed that defects occur in the secondary batteries of manufacturing numbers of 1 to 100, the center server delivers the defective battery ID information including the manufacturing numbers of 1 to 100.

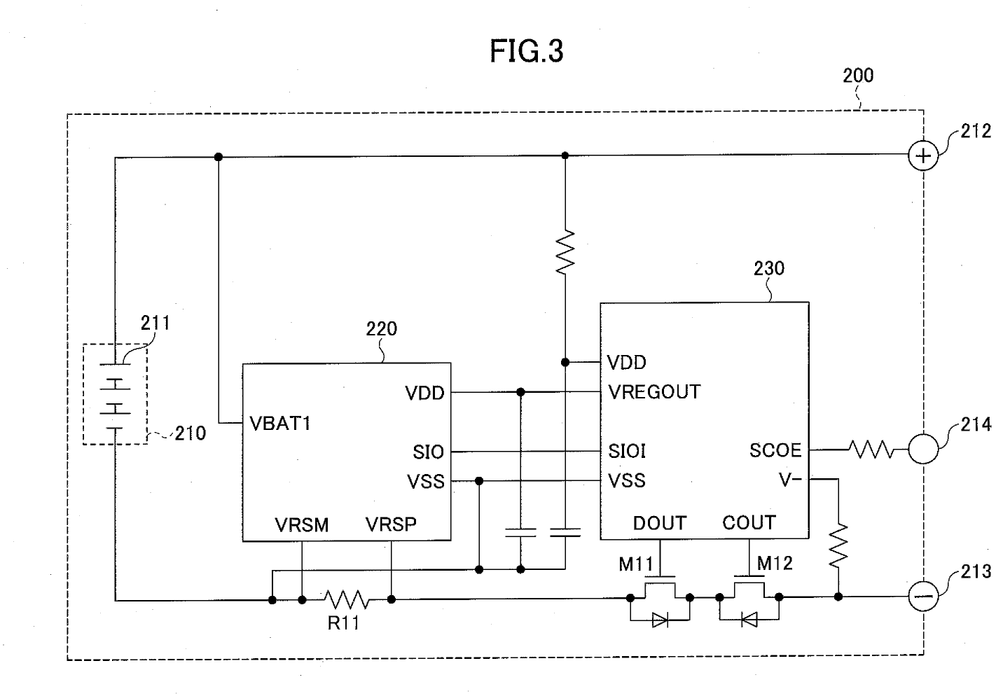

The ID information requesting unit 120 requests to obtain ID information of a secondary battery 211 (see FIG. 3) stored in a battery pack 200 from the battery pack 200 installed in the portable device 100. The ID information of the secondary battery 211 is information for identifying the secondary battery 211. The ID information is, for example, a manufacturing number or the like. The ID information of the secondary battery 211 is previously stored in a memory device or the like included in the battery pack 200.

The defect determining unit 130 determines whether the ID information is included in the defective battery ID information by comparing the defective battery ID information received by the receiving unit 110 and the ID information obtained by the ID information requesting unit 120.

The report controlling unit 140 controls reporting the defect of the secondary battery 211 when the ID information is determined to be included in the defective battery ID information by the defect determining unit 130. The report controlling unit 140 causes the display unit 12 of the portable device 100 to display an alarm indicative of the defect of the secondary battery 211 to thereby report the defect of the secondary battery 211.

Next, before describing the operations of the portable device 100, the battery pack 200 installed in the portable device 100 is described. FIG. 3 illustrates the battery pack 200 installed in the portable device 100.

The battery pack 200 includes a battery unit 210 which is formed by connecting plural of the secondary batteries 211 such as a lithium-ion battery. With Embodiment 1, the battery unit 210 is formed by serially connecting the secondary batteries 211. However, the present invention is not so limited.

The battery pack 200 includes a positive terminal 212 and a negative terminal 213, which are provided to connect the portable device 100 in which the battery pack 200 is installed, the battery unit 210, and a monitoring IC 220 and a protection IC 230 which are provided between the battery unit 210 and the positive and the negative terminals 212 and 213.

The monitoring IC 220 monitors a status of the battery unit 210 and acquires the status information of the battery unit 210. When the monitoring IC 220 receives a request referring to the status information from the portable device 100, the acquired status information is given to the portable device 100.

The monitoring IC 220 includes a power terminal VDD, a reference potential terminal. VSS, a voltage detecting terminal VBAT1, a pair of current detecting terminals VRSP and VRSM, and a communication terminal SIO. The power terminal VDD of the monitoring IC 220 receives a voltage obtained by regulating a voltage from a battery voltage by the protection IC 230. The reference potential terminal VSS is connected to the cathode of the battery unit 210.

The monitoring IC 220 can detect the output voltage of the battery unit 210 via the voltage detecting terminal VBAT1 connected to the anode of the battery unit 210. The current detecting terminal VRSM is connected to the cathode of the secondary battery 211 and further connected to the other current detecting terminal VRSP via a resistor R11 outside the monitoring IC 220.

The monitoring IC 220 detects the current flowing through the external resistor R11 via the current detecting terminals VRSP and VRSM, i.e., charge and discharge currents of the battery unit 210. The monitoring IC 220 detects an internal short of the battery unit 210. The communication terminal SIO is connected to the external terminal 214 used for communicating with the portable device 100 via the protection IC 230. The monitoring IC 220 communicates with the portable device 100 via the communication terminal SIO and the protection IC 230. The monitoring IC 220 is described in detail later.

The protection IC 230 protects the battery pack 200 from overcharge and overdischarge. The protection IC 230 includes a terminal DOUT and a terminal COUT connected to the gates of MOS transistors M11 and M12, which cut out the charge and discharge of the battery pack, respectively. The protection IC 230 cuts off the MOS transistor M11 using the DOUT output as a low level at a time of detecting the overdischarge or overcurrent. The protection IC 230 cuts off the MOS transistor M12 using the COUT output as the low level at a time of detecting the overcharge.

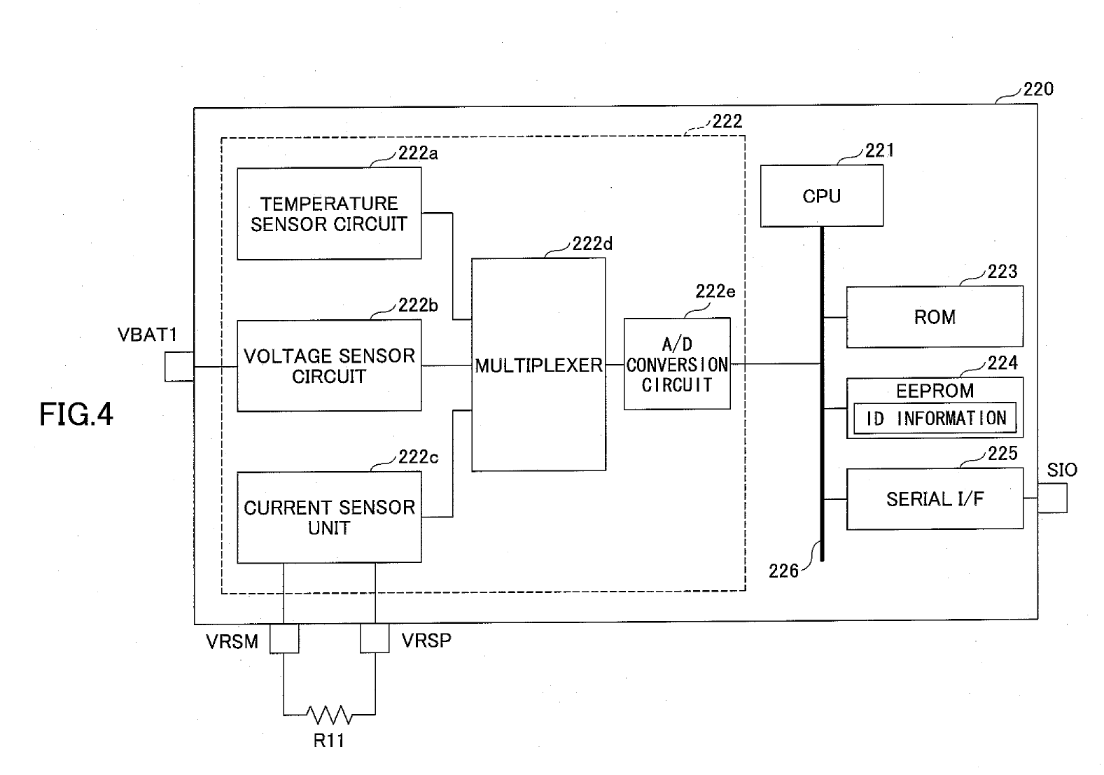

Referring to FIG. 4, the monitoring IC 220 is described in detail. FIG. 4 illustrates a hardware structure of the monitoring IC. Referring to FIG. 4, the monitoring IC 220 includes a Central Processing Unit (CPU) 221, a sensor unit 222, a Read Only Memory (ROM) 223, an Electrically Erasable and Programmable ROM (EEPROM) 224, and a serial I/F 225.

The CPU 221 controls various portions of the monitoring IC 220. The sensor part 222 detects the voltage, the current and the temperature of the battery unit 210.

The ROM 223 stores the program executed by the CPU 221 for controlling the various portions of the monitoring IC 220. The EEPROM 224 stores the ID information for identifying the battery unit 210. The ID information identifies a battery unit 210 formed by plural secondary batteries 211. However, the ID information is not so limited. For example, when the number of the secondary batteries 211 installed in the battery pack is one, the ID information may be information for identifying the secondary battery 211. The EEPROM 224 stores information of the various parameters of the voltage, current and temperature of the battery unit 210, which are detected by the sensor unit 222.

The serial I/F 225 communicates with the portable device 100 via the communication terminal SIO. For example, when the monitoring IC 220 is requested to send ID information to the portable device 100, the CPU 221 reads ID information from the ROM 223 and sends the ID information to the portable device 100 via the communication terminal SIO.

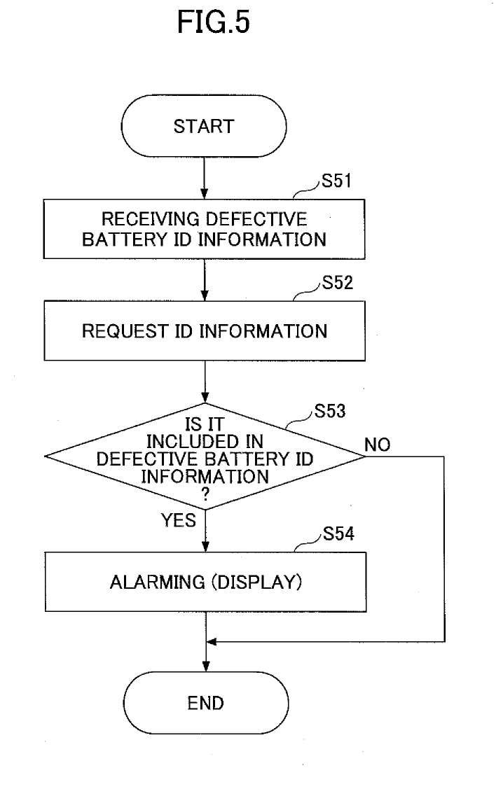

The CPU 221, the sensor unit 222, the ROM 223, the EEPROM 224 and the serial I/F 225 are connected via a bus 226. Data and programs are exchanged among the CPU 221, the sensor unit 222, the ROM 223, the EEPROM 224 and the serial I/F 225. The sensor unit 222 includes a temperature sensor circuit 222a, a voltage sensor circuit 222b, a current sensor circuit 222c, a multiplexer 222d and an analog-digital (A/D) conversion circuit 222e. The temperature sensor circuit 222a detects the temperature of the battery unit 210. The voltage sensor circuit 222b detects the output voltage of the battery unit 210 via the voltage detecting terminal VBAT1 connected to the battery unit 210. The current sensor circuit 222c detects the current flowing through the external resistor R11 via the current detecting terminals VRSP and VRSM, i.e., the charge and discharge currents of the battery unit 210. Outputs from the temperature sensor circuit 222a, the voltage sensor circuit 222b, and the current sensor circuit 222c are connected to the multiplexer 222d. These outputs are output as one signal by the multiplexer 222d. The A/D conversion circuit 222e converts the output signal output by the multiplexer 222d from analogue to digital. Next, referring to FIG. 5, the operation of the portable device 100 is described. FIG. 5 is a flowchart illustrating an operation of the portable device. The portable device 100 receives the defective battery ID information with the defective battery ID information receiving unit 110 when the defective battery ID information is delivered from a center server in step S51. Next, the portable device 100 requests the ID information from the ID information requesting unit 120 and obtains the ID information from the monitoring IC 220 in step S52.

After the portable device 100 obtains the ID information, the portable device 100 determines whether the ID information is included in the defective battery ID information by comparing the ID information to the defective battery ID information with the defect determining unit 130 in step S53.

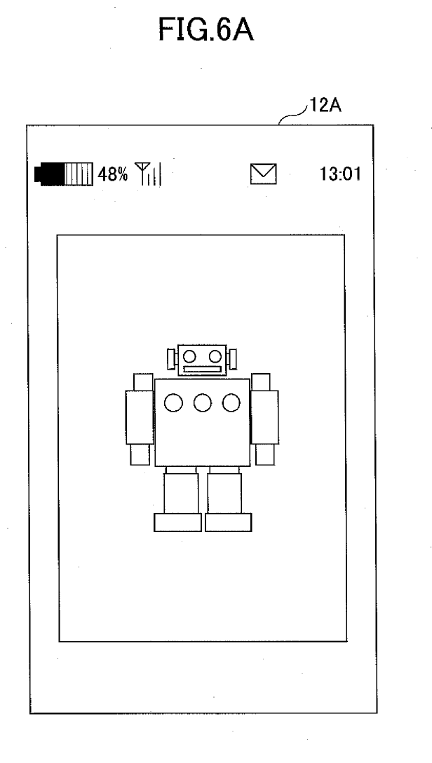

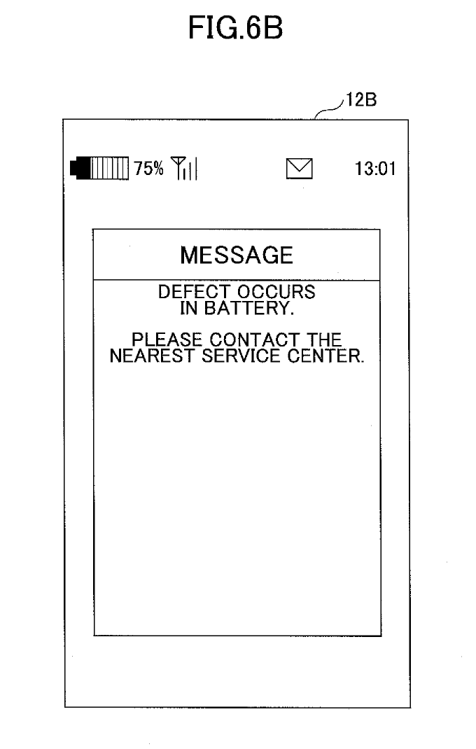

In step S53, if the ID information is included in the defective battery ID information, the report controlling unit 140 reports that the battery unit 210 of the battery pack installed in the portable device 100 is defective in step S54. In NO of step S53, if the ID information is not included in the defective battery ID information, the report controlling unit 140 does not report that the battery unit 210 of the battery pack 200 installed in the portable device 100 is defective as the battery unit 210 of the battery pack installed in the portable device 100 is not defective. Referring to FIG. 6A and FIG. 6B, the report controlling unit 140 is described. FIG. 6A is an exemplary report made with a report control unit. FIG. 6A is an example of a case where the report controlling unit 140 does not report, and FIG. 6B is an example of a case where the report controlling unit 140 reports.

When the ID information obtained from the battery pack 200 is not included in the defective battery ID information, the battery unit 210 is not defective. Therefore, the report controlling unit 140 does not display a message indicative of a defective battery on a screen 12A displayed on the display unit 12 as illustrated in FIG. 6A.

When the ID information obtained from the battery pack 200 is included in the defective battery ID information, the corresponding battery unit 210 is defective. Referring to FIG. 6B, the report controlling unit 140 causes a screen 12B to be displayed on the display unit 12 that displays a report message indicative of a defect of the battery unit 210.

With the Embodiment, it is possible to surely report to the user that the defect occurs in a case where the battery unit 210 (the secondary battery 211) installed in the portable device 100 after the portable device 100 is delivered to the market with the following structure. Therefore, it is possible to prevent the user from continuously using the defective battery unit and the safety of the user can be improved. With the Embodiment, the user can recognize that the secondary battery 211 is defective even if the defect of the secondary battery is not positively checked.

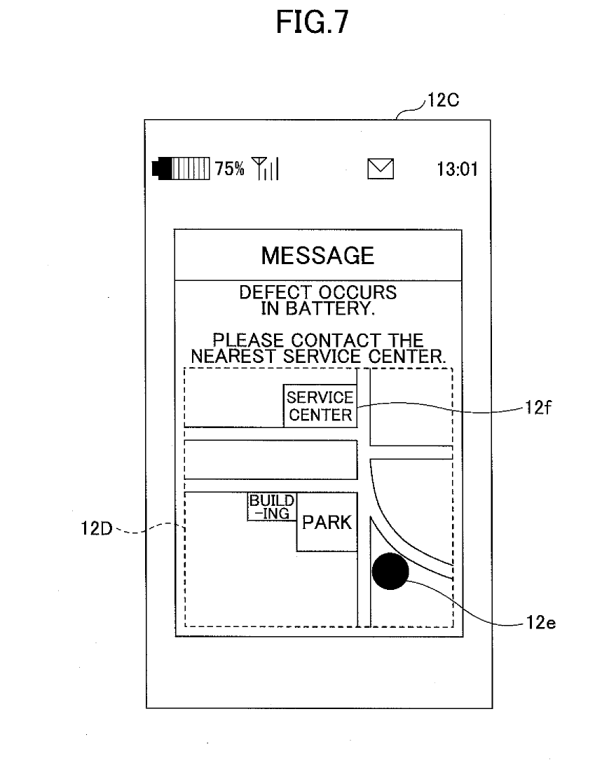

When the defect of the battery unit 210 (the secondary battery 211) is reported, the report controlling unit 140 may display a report message along with map information indicating the nearest service center. FIG. 7 illustrates an example on which a report message is displayed along with the map information.

A screen 120 illustrated in FIG. 7 displays a report message and map information 12D on the display unit 12. In a case where the map information 12D is displayed, the defective battery ID information receiving unit 110 receives the defective battery ID information and the map information 12D indicative of the location of the nearest service center.

When the map information 12D is received, the portable device 100 sends the positional information of the portable device 100 to the center server. The center server sends the map information 12d of the nearest service center for the portable device 100 to the portable device 100 based on the positional information of the portable device 100. The map information 12D preferably includes present location information 12e indicative of the portable device 100 and positional information 12f indicative of the location of the service center.

As described, by displaying the positional information of the nearest service center along with the report message, the user can rapidly go to the service center.

Although, with the Embodiment, the report controlling unit 140 reports by displaying the report message on the display unit, the present invention is not so limited. For example, the report controlling unit 140 may report a defect of the battery unit 210 by a vibration function of the portable device 100 if the report controlling unit 140 determines that the ID information obtained from the battery pack 200 is included in the defective battery ID information. For example, the vibration function may be realized by a motor for generating vibration built in the portable device 100. The report controlling unit 140 may signal the defect of the battery unit 210 by ringing a warning beeper.

### APPENDIX

In order to facilitate understanding of claims and the Embodiment, reference symbols are attached to the following explanation. However, the explanation is an example and the present invention is not limited to the figures and the reference symbols in the explanation.

According to the Embodiment, there is provided a portable device (100) which is driven by a chargeable and dischargeable secondary battery (211) mounted on a battery pack (200) having a memory circuit (224) in which identification information of the secondary battery (211) is stored, the portable device (100) including:

a defective battery information receiving unit (110) configured to receive defective battery information which is delivered from a defective battery ID information delivering organization;

a requesting unit (120) configured to request to obtain the identification information of the secondary battery stored in the memory circuit (224);

a determining unit (130) configured to determine whether the identification information of the secondary battery is included in the defective battery information; and

a report controlling unit (140) configured to report a defect of the secondary battery (211) if it is determined by the determining unit (130) that the identification information of the secondary battery is included in the defective battery information.

Further, the portable device includes a display unit (12), and the report controlling unit (140) displays a report of the defect in the secondary battery (211).

Further, in the portable device, the report controlling unit (140) makes the display unit (12) display map information (12D) including present location information (12e) of the portable device (100) received from the defective battery ID information delivering organization and positional information (12f) of a place where the secondary battery (211) can be exchanged and a report indicative of the defect of the secondary battery (211).

Further, the portable device further includes a vibration generating unit, and the report controlling unit (140) reports the defect of the secondary battery (211) by generating vibration with the vibration generating unit.

According to the Embodiment, there is provided a reporting method with a portable device (100) which is driven by a chargeable and dischargeable secondary battery (211) mounted on a battery pack (200) having a memory circuit (224) in which identification information of the secondary battery (211) is stored, the reporting method including:

receiving (S51) defective battery information which is delivered from a defective battery ID information delivering organization;

requesting (S52) to obtain the identification information of the secondary battery stored in the memory circuit (224);

determining (S53) whether the identification information of the secondary battery is included in the defective battery information; and

reporting (S54) a defect of the secondary battery (211) if it is determined by the determining (S53) that the identification information of the secondary battery (211) is included in the defective battery information.

According to the Embodiment, there is provided a reporting program which is executed by a portable device (100) which is driven by a chargeable and dischargeable secondary battery (211) and includes a battery pack (200) mounted on a memory circuit (224) in which identification information of the secondary battery (211) is stored, the reporting program that causes the portable device to perform a procedure, the procedure including:

receiving (S51) defective battery information which is delivered from a defective battery ID information delivering organization;

requesting (S52) to obtain the identification information of the secondary battery stored in the memory circuit (224);

determining (S53) whether the identification information of the secondary battery is included in the defective battery information; and

reporting (S54) a defect of the secondary battery (211) if it is determined by the determining (S53) that the identification information of the secondary battery (211) is included in the defective battery information.

According to the Embodiment, there is provided a battery pack (200) for driving a portable device (100) and having a memory circuit (224) in which identification information of a chargeable and dischargeable secondary battery (211) is stored, the battery pack (200) including:

a defective battery information receiving unit (110) configured to receive defective battery information which is delivered from a defective battery ID information delivering organization;

a requesting unit (120) configured to request to obtain the identification information of the secondary battery stored in the memory circuit (224);

a determining unit (130) configured to determine whether the identification information of the secondary battery is included in the defective battery information; and

a report controlling unit (140) configured to report a defect of the secondary battery (211) if it is determined by the determining unit (130) that the identification information of the secondary battery is included in the defective battery information.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

This patent application is based on Japanese Priority Patent Application No. 2009-162421 filed on Jul. 9, 2009, the entire contents of which are hereby incorporated herein by reference.

### EXPLANATION OF REFERENCE SIGNS

100: portable device

110: defective battery ID information receiving unit

120: ID information requesting unit

130: defect determining unit

140: report control unit

200: battery pack

210: battery unit

211: secondary battery

220: monitoring IC

1. A portable device driven by a chargeable and dischargeable secondary battery mounted on a battery pack having a memory circuit in which identification information of the secondary battery is stored, the portable device comprising:
a defective battery information receiving unit configured to receive defective battery information delivered from a defective battery ID information delivering organization;
a requesting unit configured to request obtaining the identification information of the secondary battery stored in the memory circuit;
a determining unit configured to determine whether the identification information of the secondary battery is included in the defective battery information; and
a report controlling unit configured to report a defect of the secondary battery if it is determined by the determining unit that the identification information of the secondary battery is included in the defective battery information.

2. The portable device according to claim 1, further comprising:
a display unit;
wherein the report controlling unit displays a report of the defect in the secondary battery.

3. The portable device according to claim 2,
wherein the report controlling unit causes the display unit to display map information including present location information of the portable device received from the defective battery ID information delivering organization and positional information of a place where the secondary battery can be exchanged and a report indicative of the defect of the secondary battery.

4. The portable device according to claim 1, further comprising:
a vibration generating unit,
wherein the report controlling unit reports the defect of the secondary battery by generating a vibration with the vibration generating unit.

5. A reporting method with a portable device which is driven by a chargeable and dischargeable secondary battery mounted in a battery pack having a memory circuit in which identification information of the secondary battery is stored, the reporting method comprising:
receiving defective battery information which is delivered from a defective battery ID information delivering organization;
requesting the identification information of the secondary battery stored in the memory circuit;
determining whether the identification information of the secondary battery is included in the defective battery information; and
reporting a defect of the secondary battery if it is determined by the determining that the identification information of the secondary battery is included in the defective battery information.

6. A reporting program which is executed by a portable device which is driven by a chargeable and dischargeable secondary battery mounted on a battery pack having a memory circuit in which identification information of the secondary battery is stored, the reporting program that causes the portable device to perform a procedure, the procedure comprising:
receiving defective battery information which is delivered from a defective battery ID information delivering organization;
requesting the identification information of the secondary battery stored in the memory circuit;
determining whether the identification information of the secondary battery is included in the defective battery information; and
reporting a defect of the secondary battery if it is determined by the determining that the identification information of the secondary battery is included in the defective battery information.

7. A battery pack for driving a portable device and having a memory circuit in which identification information of a chargeable and dischargeable secondary battery is stored, the battery pack comprising:
a defective battery information receiving unit configured to receive defective battery information which is delivered from a defective battery ID information delivering organization;
a requesting unit configured to request the identification information of the secondary battery stored in the memory circuit;
a determining unit configured to determine whether the identification information of the secondary battery is included in the defective battery information; and
a report controlling unit configured to report a defect of the secondary battery if it is determined by the determining unit that the identification information of the secondary battery is included in the defective battery information.
